(19) United States
(12) Patent Application Publication
(10) Pub. No.: US 2018/0121003 A1
(43) Pub. Date: May 3, 2018

(54) TOUCH SYSTEM AND TOUCH METHOD THEREOF

(71) Applicant: Coretronic Corporation, Hsin-Chu (TW)

(72) Inventors: Ming-Te Lin, Hsin-Chu (TW); Cheng-Shen Lee, Hsin-Chu (TW); Yung-Chih Chen, Hsin-Chu (TW)

(73) Assignee: Coretronic Corporation, Hsin-Chu (TW)

(21) Appl. No.: 15/794,005

(22) Filed: Oct. 26, 2017

(30) Foreign Application Priority Data
Oct. 27, 2016 (CN) 201610954224.5

(51) Int. Cl. G06F 3/041; G06F 3/0354

(52) U.S. Cl. CPC G06F 3/0414; G06F 3/03545; G06F 3/0412

(57) ABSTRACT

A touch system and a touch method thereof are provided. A signal receiving apparatus of the touch system receives a first light signal and a pressure sensing signal sent by a touch apparatus. A computing apparatus of the touch system judges a touch position of the touch apparatus according to the first light signal, and decides an expected size of a touch trajectory according to the pressure sensing signal, so as to produce a corresponding touch effect in response to a magnitude of a pressing force, and improve applicability of the touch system.

### CROSS-REFERENCE TO RELATED APPLICATION

This application claims the priority benefit of China application serial no. 201610954224.5, filed on Oct. 27, 2016. The entirety of the above-mentioned patent application is hereby incorporated by reference herein and made a part of this specification.

### BACKGROUND OF THE INVENTION

### Field of the Invention

The invention relates to an electronic apparatus, and particularly relates to a touch system and a touch method thereof.

### Description of Related Art

Touch apparatuses are roughly divided into resistive touch apparatuses, capacitive touch apparatuses, optical touch apparatuses, acoustic wave touch apparatuses and electromagnetic touch apparatuses according to different sensing methods, and a position of a finger or a stylus is determined by capturing a touch region touched by the finger or the stylus. However, a touch effect and applications thereof are still limited.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention is directed to a touch system and a touch method of the touch system, which are adapted to improve applicability of the touch system.

Other objects and advantages of the invention can be further illustrated by the technical features broadly embodied and described as follows.

In order to achieve one or a portion of or all of the objects or other objects, an embodiment of the invention provides a touch system including a touch apparatus, a signal receiving apparatus, and a computing apparatus. When a touch region is touched, the touch apparatus sends an indication signal. The indication signal has a first light signal and a pressure sensing signal generated by the touch apparatus by sensing a feedback pressure of the touch region. The signal receiving apparatus is configured to receive the first light signal and the pressure sensing signal from the touch apparatus. The signal receiving apparatus includes an image capturing circuit. The image capturing circuit is configured to receive the first light signal, and generates a coordinate signal according to a touch position of the first light signal on the touch region. The computing apparatus is coupled to the signal receiving apparatus, and is configured to receive the coordinate signal and the pressure sensing signal from the signal receiving apparatus, and is configured to judge the touch position of the touch apparatus according to the coordinate signal, and is configured to decide an expected size of a touch trajectory according to the pressure sensing signal.

The invention provides a touch method of a touch system, which includes following steps. A signal receiving apparatus is provided, and an indication signal sent by a touch apparatus when the touch apparatus touches a touch region is received, wherein the indication signal has a first light signal and a pressure sensing signal generated by the touch apparatus by sensing a feedback pressure of the touch region. An image capturing circuit of the signal receiving apparatus is provided to receive the first light signal, and a coordinate signal is generated according to a touch position of the first light signal on the touch region. A computing apparatus is provided to receive the coordinate signal and the pressure sensing signal from the signal receiving apparatus, and the touch position of the touch apparatus is judged according to the coordinate signal, and an expected size of a touch trajectory is decided according to the pressure sensing signal.

According to the above description, the signal receiving apparatus of the touch system may receive the first light signal and the pressure sensing signal sent by the touch apparatus. Moreover, the computing apparatus of the embodiment of the invention judges the touch position of the touch apparatus according to the first light signal and decides the expected size of the touch trajectory according to the pressure sensing signal, so as to generate a corresponding touch effect in response to a magnitude of a pressing force to improve applicability of the touch system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch system according to an embodiment of the invention.

FIG. 2 is a schematic diagram of a touch trajectory according to an embodiment of the invention.

FIG. 3 is a schematic diagram of a touch system according to another embodiment of the invention.

FIG. 3A is a schematic diagram of a voltage-dividing circuit according to an embodiment of the invention.

FIG. 3B is a schematic diagram of a relationship between forces exerted to a head portion and digital values output by an analog-to-digital converter (ADC) according to an embodiment of the invention.

FIG. 4 is a schematic diagram of a touch system according to another embodiment of the invention.

FIG. 5 is a flowchart illustrating a touch method of a touch system according to an embodiment of the invention.

FIG. 6 is a flowchart illustrating a touch method of a touch system according to another embodiment of the invention.

FIG. 7A is a flowchart illustrating a touch method of a touch system according to still another embodiment of the invention.

FIG. 7B is a flowchart illustrating a touch method of a touch system according to still another embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

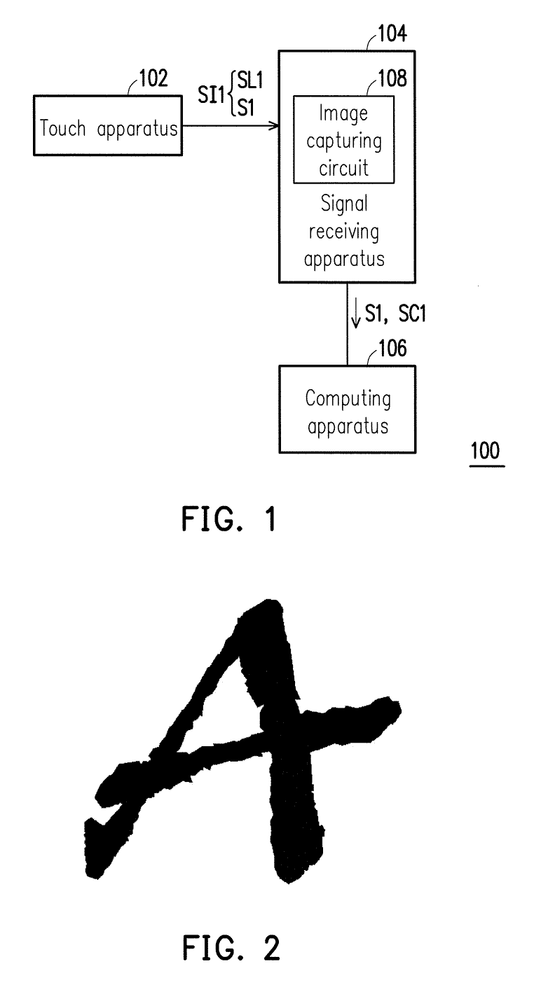

FIG. 1 is a schematic diagram of a touch system according to an embodiment of the invention. Referring to FIG. 1, the touch system 100 includes a touch apparatus 102, a signal receiving apparatus 104 and a computing apparatus 106, wherein the signal receiving apparatus 104 includes an image capturing circuit 108, and the signal receiving apparatus 104 is coupled to the computing apparatus 106.

In the embodiment, a projector may be applied to the touch system 100 to implement an interactive projection system. In the embodiment, the projector may be a liquid crystal projector (LCP), a digital light processing (DLP) projector or a liquid crystal on silicon (LCOS) projector, though the invention is not limited thereto.

In the embodiment, the image capturing circuit 108 may be a camera, a complementary metal-oxide-semiconductor (CMOS) transistor, a charge-coupled apparatus (CCD), a color sensor, an infrared sensor (IR sensor), a near-infrared sensor (NIR sensor), etc., though the invention is not limited thereto, and any proper visible light sensor or invisible light sensor may serve as the image capturing circuit of the invention. In the embodiment, the image capturing circuit 108 is, for example, built in the projector, and taking an interactive projection apparatus having a camera as an example, a DELL projector with a model No. S560T, S560P or an Optoma projector with a model No. EH320USTi may be used to implement the projector with a built-in camera of the embodiment, though the invention is not limited thereto. In other embodiments, the image capturing circuit 108 may also be disposed outside the projector, and the invention is still not limited thereto.

In the embodiment, the computing apparatus 106 may be a processor, a central processing unit (CPU), a micro-processor, a controller, a micro control unit (microcontroller unit, MCU), a digital signal processor (DSP), a programmable controller, an application specific integrated circuit (ASIC), a programmable logic apparatus (PLD), a complex programmable logic apparatus (CPLD), a network computer, though the invention is not limited thereto. In the embodiment, the computing apparatus 106 is, for example, configured in a computer, a personal computer (PC), a notebook computer (notebook PC, notebook, NB, laptop computer, laptop), a tablet computer (tablet) or a smart phone, though the invention is not limited thereto. In some embodiments, the computing apparatus 106 may also be built in a projector (not shown), though the invention is still not limited thereto. In some embodiments, the image capturing circuit 108 and the computing apparatus 106 may also be integrated into one electronic apparatus, for example, a computer apparatus (for example, a PC/micro-computer/notebook/tablet PC/smart phone) having a camera or a camera having the computing apparatus 106 or a computing capability.

In the embodiment, when the touch apparatus 102 contacts a touch region (for example, a wall surface, a projection screen, an electronic whiteboard, a touch board or a touch display panel), the touch apparatus 102 may send an indication signal SI1. The indication signal SI1, for example, includes a first light signal SL1 and a pressure sensing signal S1 produced by the touch apparatus 102 by sensing a feedback pressure of the touch region, wherein the first light signal SL1 is, for example, a light signal. In the embodiment, the feedback pressure is a reaction force given to the touch apparatus 102 by the touch region when the touch apparatus 102 contacts the touch region. Namely, in the embodiment, when the touch apparatus 102 does not contact the touch region the touch apparatus 102 does not emit light. Conversely, when the touch apparatus 102 contacts the touch region, the touch apparatus 102 not only emits light (for example, sends the first light signal SL1), but also produce the pressure sensing signal S1 corresponding to a magnitude of a pressing force of the touch apparatus 102. For example, it is assumed that the touch apparatus 102 is a touch pen, when the user holds the touch pen to contact the touch region to perform a touch operation, the touch pen may sense a corresponding reaction force coming from the touch region along with different forces exerted to the touch region by the touch pen. The signal receiving apparatus 104 receives the first light signal SL1 and the pressure sensing signal S1 coming from the touch apparatus 102 (the touch pen), wherein the pressure sensing signal S1 corresponds to a magnitude of the pressing force of the touch pen. The image capturing circuit 108 of the signal receiving apparatus 104 receives the first light signal SL1, and generates a coordinate signal SC1 according to a touch position of the first light signal SL1 on the touch region. Moreover, the computing apparatus 106 receives the coordinate signal SC1 and the pressure sensing signal S1 coming from the signal receiving apparatus 104, and judges a touch position of the touch apparatus 102 according to the coordinate signal SC1, and decides an expected size of a touch trajectory according to the pressure sensing signal S1. In the embodiment, the touch trajectory is a trace or trajectory formed by the touch apparatus 102 on the touch region when the touch apparatus 102 contacts the touch region, for example, a trace formed on the touch region when the touch apparatus 102 contacts the touch region, or a trajectory formed on the touch region when the touch apparatus 102 moves on the touch region. In the embodiment, the touch trajectory may include dots, lines, planes or any combination dots, lines and planes. Moreover, the touch operation performed by the touch apparatus 102 of the embodiment may be a single-touch operation or multi-touch operation. In the embodiment, when the touch apparatus 102 moves on the touch region, the image capturing circuit 108 of the signal receiving apparatus 104 may synchronously receive the first light signal SL1 coming from the touch apparatus 102 to make the computing apparatus 106 to synchronously receive the coordinate signal SC1 coming from the image capturing circuit 108 of the signal receiving apparatus 104, and the signal receiving apparatus 104 may synchronously receive the pressure sensing signal S1 coming from the touch apparatus 102 to make the computing apparatus 106 to synchronously receive the pressure sensing signal S1 coming from the signal receiving apparatus 104, such that the computing apparatus 106 may judge the touch position of the touch apparatus 102 according to the coordinate signal SC1 and decide an expected size of the touch apparatus 102 according to the pressure sensing signal S1. In this way, the touch trace displayed on the touch region has a corresponding trace size or stroke severity (the expected size), so as to implement the multi-touch operation to improve a visual effect of interactive display.

According to the above description, in the embodiment, the image capturing circuit 108 of the signal receiving apparatus 104 receives the first light signal SL1 sent by the touch apparatus 102 and the signal receiving apparatus 104 receives the pressure sensing signal S1, and the computing apparatus 106 judges the touch position of the touch apparatus 102 according to the first light signal SL1 and decides an expected size of the touch trajectory according to the pressure sensing signal S1, so as to produce a corresponding touch effect in response to a magnitude of the pressing force to improve applicability of the touch system. For example, the touch region is, for example, a display surface (for example, a projection surface, a projection screen, an electronic whiteboard or a display surface of a touch display panel), when the touch apparatus 102 performs a touch operation on the display surface, the computing apparatus 106 may decide a display image on the touch position of the display surface (the touch region) to have a touch trajectory with a corresponding trace thickness degree (the expected size) according to the coordinate signal SC1 and the pressure sensing signal S1. For example, a touch trajectory “ [symbol] ” displayed on the display surface of FIG. 2, and the touch system 100 of the embodiment of FIG. 1 may change a thickness of displayed traces according to a feedback pressure of the touch region during the touch operation, such that the user may conveniently and intuitively control a stroke severity to improve the visual effect of the interactive display. Moreover, since the touch trajectory includes dots, lines, planes or any combination of dots, lines and planes, when the touch apparatus 102 performs a multi-touch operation, the display surface may synchronously display a touch trajectory formed by a combination of a plurality of dots, lines and/or planes corresponding to the multi-touch operation.

To be specific, in the embodiment, the touch system 100, for example, has a touch pen, a projector and a projection surface (for example, a wall surface or a projection screen). The touch pen serves as a touch apparatus, and the projection surface serving as a display region has the touch region. The computing apparatus 106 may be a computer coupled to the projector (not shown), and the computing apparatus 106 may also be a processor built in the projector, and the computing apparatus 106 may control the projector to display a stroke severity corresponding to the pressing force according to the pressing force of the touch pen on the touch region, so as to improve the visual effect of the interactive projection system. However, the application of the invention is not limited to display a touch trajectory with thick and thin traces. In other embodiments, the computing apparatus 106 may also execute other operation according to the expected size (for example, a thickness of the traces or severity of a stroke) of the touch trajectory. For example, in other embodiments, the touch system 100 is, for example, an electronic apparatus having a touch function such as a notebook computer, a tablet computer, etc., and the computing apparatus 106 is, for example, a processor in the electronic apparatus having the touch function such as a notebook computer, a tablet computer, etc., such that the computing apparatus 106 may perform volume adjustment and brightness adjustment of the image according to the expected size (for example, a thickness of the traces or severity of a stroke) of the touch trajectory, so as to further improve application possibility of the touch system 100. However, the application of the invention is not limited thereto.

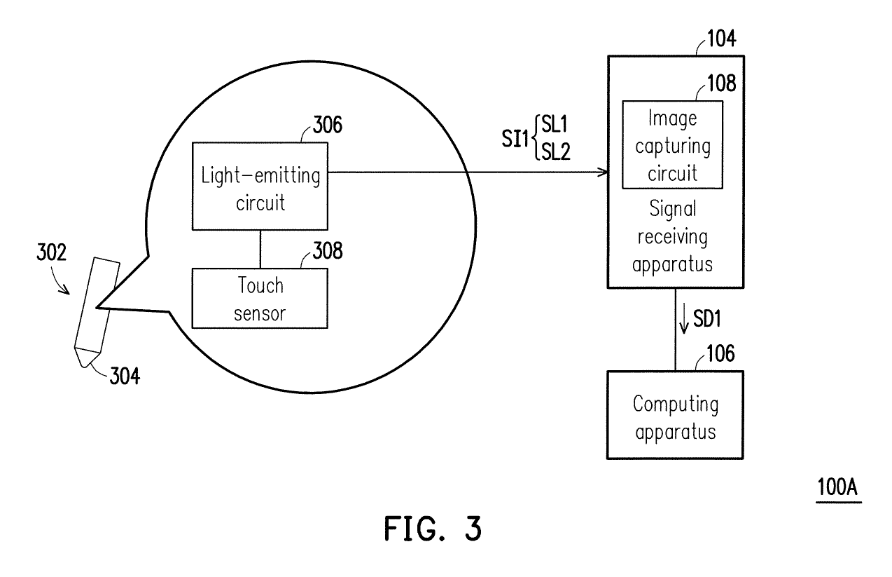

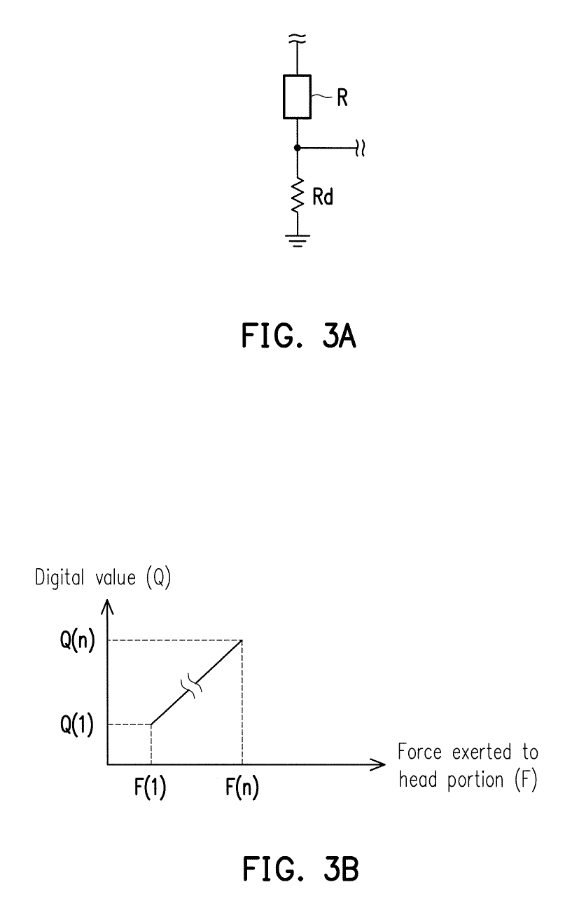

FIG. 3 is a schematic diagram of a touch system according to another embodiment of the invention. Referring to FIG. 3, in the touch system 100A of the embodiment, the touch apparatus 302 is a touch pen including a head portion 304, a light-emitting circuit 306 and a touch sensor 308. In the embodiment, the head portion 304 is configured to contact the touch region, and the head portion 304 is, for example, a electroconductive rubber having a variable resistance (which is described later), though the invention is not limited thereto. In the embodiment, the light-emitting circuit 306 is coupled to the touch sensor 308 and the head portion 304, and the touch sensor 308 is coupled to the head portion 304. The touch sensor 308, for example, has a voltage-dividing resistor, an analog-to-digital converter (ADC) and a current control circuit, and the light-emitting circuit 306, for example, has a light-emitting element, though the invention is not limited thereto. To be specific, referring to a following table 1, FIG. 3 and FIG. 3A, in the embodiment, the variable resistance R of the head portion 304 (for example, the electroconductive rubber) is, for example, connected in series with a voltage-dividing resistor Rd of the touch sensor 308 to form a voltage-dividing circuit, and since a force F exerted to the head portion 304 is related to the variable resistance R of the head portion 304, the force F sustained by the head portion 304 may be transformed into a corresponding voltage-dividing value (which is referred to as a voltage value V hereinafter) through the voltage-dividing circuit (shown in FIG. 3A), and the voltage value V may be converted into a corresponding digital value Q through the ADC, and the digital value Q is transformed into a corresponding current value I through the current control circuit, wherein the current value I may decide an optical characteristic (which is described later) of the light-emitting element of the light-emitting circuit 306, though the invention is not limited thereto. Regarding the optical characteristic of the light-emitting element, a brightness value L (or a gray level value) of the light-emitting element of the light-emitting circuit 306 during a light-emitting process of the light-emitting element is taken as example for description in the table 1, though the invention is not limited thereto. Moreover, the circuit design of the touch apparatus 302 (for example, the touch pen) is taken as an example for description, though the invention is not limited thereto, namely, any proper circuit design may be adopted to serve as the touch apparatus of the invention.

TABLE 1

| Force F | | | | | |
|---|---|---|---|---|---|
| exerted | Variable | Voltage | Digital | Current | Brightness |
| to head | resistance | value | value | value | value |
| portion | R | V | Q | I | L |
| F(1) | R(1) | V(1) | Q(1) | I(1) | L(1) |
| F(i − 1) | R(i − 1) | V(i − 1) | Q(i − 1) | I(i − 1) | L(i − 1) |
| F(i) | R(i) | V(i) | Q(i) | I(i) | L(i) |
| F(i + 1) | R(i + 1) | V(i + 1) | Q(i + 1) | I(i + 1) | L(i + 1) |
| F(n) | R(n) | V(n) | Q(n) | I(n) | L(n) |

According to the above description, corresponding relationships of the force F exerted to the head portion 304, the variable resistance R of the head portion 304, the voltage value V obtained through the voltage-dividing circuit, the digital value Q converted by the ADC, the current value I converted by the current control circuit and the brightness value (gray level value) of the light-emitting element of the light-emitting circuit 306 may be learned from the table 1, and the corresponding relationships may be presented by a look-up table, though the invention is not limited thereto. According to another aspect, as shown in FIG. 3B, in the embodiment, F and Q in the table 1, for example, present a linear relationship, though the invention is not limited thereto. However, the aforementioned corresponding relationships are only an example, and in other embodiments, F and Q in the table 1 may present a non-linear relationship. Moreover, in other embodiments, the parameters F, R, V, Q, I or/and L in the table 1 are not limited to be specific values, which may respectively be a value range of a certain section, though the invention is still not limited thereto. In other embodiments, the corresponding relationship of the force F exerted to the head portion 304 an other parameter (for example, the voltage value V or the current value I) may be used as a reference for determining the brightness value L (gray level value) of the light-emitting element of the light-emitting circuit 306 when the light-emitting element emits light, though the invention is still not limited thereto. In other embodiments, the relationship between the force F exerted to the head portion 304 and the brightness value L (gray level value) of the light-emitting element of the light-emitting circuit 306 when the light-emitting element emits light may be implemented through an algorithm, though the invention is still not limited thereto.

According to the above description, it is known that different forces F may be exerted to the head portion 304 to make the light-emitting circuit 306 to correspondingly present different optical characteristics (for example, the brightness value L), and the signal receiving apparatus 104 receives the different optical characteristic from the light-emitting circuit 306 to make the computing apparatus 106 to decide a size of the touch trajectory according to the different optical characteristic. However, the aforementioned optical characteristic presented by the light-emitting circuit 306, for example, adopts the brightness value L (or the gray level value) to represent a light intensity, though the invention is not limited thereto. For example, in other embodiments, the optical characteristic presented by the light-emitting circuit 306 may adopt an overall contour size of light spot, which is not limited by the invention.

According to another aspect, since the brightness value L (the gray level value) in the table 1 is related to the force F exerted to the head portion 304, i.e. the optical characteristic (for example, the brightness value, the gray level value, the light intensity, or a contour size of the light spot) presented by the light-emitting circuit 306 is related to the pressure sensing signal, a signal containing the brightness value L may be used to implement the pressure sensing signal. To be specific, in the embodiment, when the head portion 304 touches the touch region to perform a touch operation, the light-emitting circuit 306 sends the first light signal SL1. In the embodiment, the touch sensor 308 senses a feedback pressure of the touch region when the head portion 304 touches the touch region, and controls the light-emitting circuit 306 to generate the pressure sensing signal according to the feedback pressure. In the embodiment, a second light signal SL2 serves as the pressure sensing signal. In the embodiment, the light-emitting circuit 306 may be controlled by the touch sensor 308 to adjust a light intensity (brightness or gray level value) of the second light signal SL2 (the pressure sensing signal), and the overall contour size, color or wavelength, etc., of the light spot according to the feedback pressure, so as to adjust the optical characteristic of the indication signal SI1. For example, when the touch sensor 308 senses a larger pressing force, the light-emitting circuit 306 may be adjusted to emit a brighter light; and when the touch sensor 308 senses a smaller pressing force, the light-emitting circuit 306 may be adjusted to emit a dimmer light. When the touch sensor 308 senses a larger pressing force, the light-emitting circuit 306 may be adjusted to emit a red light; and when the touch sensor 308 senses a smaller pressing force, the light-emitting circuit 306 may be adjusted to emit a green light. When the touch sensor 308 senses a larger pressing force, the light-emitting circuit 306 may be adjusted to emit a light signal with a visible light wavelength/waveband; and when the touch sensor 308 senses a smaller pressing force, the light-emitting circuit 306 may be adjusted to emit a light signal with an invisible light wavelength/waveband, though the invention is not limited thereto.

In the embodiment, the image capturing circuit 108 may capture an image on the touch region. In detail, in the embodiment, since the first light signal SL1 and the second light signal SL2 all belong to light signals, the image capturing circuit 108 of the signal receiving apparatus 104 may capture the first light signal SL1 and the second light signal SL2 in the indication signal SI1, so as to provide optical characteristic information SD1 to the computing apparatus 106 according to the optical characteristic of the indication signal SI1. In the embodiment, the optical characteristic information SD1 includes a coordinate signal corresponding to the first light signal SL1 and a pressure sensing signal corresponding to the second light signal SL2. For example, the image captured by the image capturing circuit 108 probably has light spot images of different sizes due to different light intensities of the indication signal SI1. In the embodiment, a center point image of the light spot images may be taken as the first light signal SL1 to decide the coordinate signal, and the cneter point image of the light spot images may be obtained through a triangulation positing method, a coordinate transformation method, etc., so as to obtain the coordinate signal, though the invention is not limited thereto. In the embodiment, a brightness (gray level value or light intensity) of the light spot image may be taken as the second light signal SL2 to decide the expected size of the touch trajectory, though the invention is not limited thereto. In other embodiments, the center point image of the light spot images may be taken as the first light signal SL1 to decide the coordinate signal, and the overall contour size of the light spot images may be taken as the second light signal SL2 to decide the expected size of the touch trajectory, wherein the center point image of the light spot images and the overall contour size of the light spot images may also be obtained through the triangulation positing method, the coordinate transformation method, etc., so as to obtain the coordinate signal and the expected size of the touch trajectory, though the invention is still not limited thereto. In the embodiment, the image capturing circuit 108 may provide the optical characteristic information SD1 to the computing apparatus 106 according to the first light signal SL1 and the second light signal SL2, and the computing apparatus 106 may judge the touch position of the touch apparatus 302 and decide the expected size of the touch trajectory according to the optical characteristic information SD1. In the embodiment, application implemented by the computing apparatus 106 based on the expected size of the touch trajectory has been described in the aforementioned embodiment, and detail thereof is not repeated.

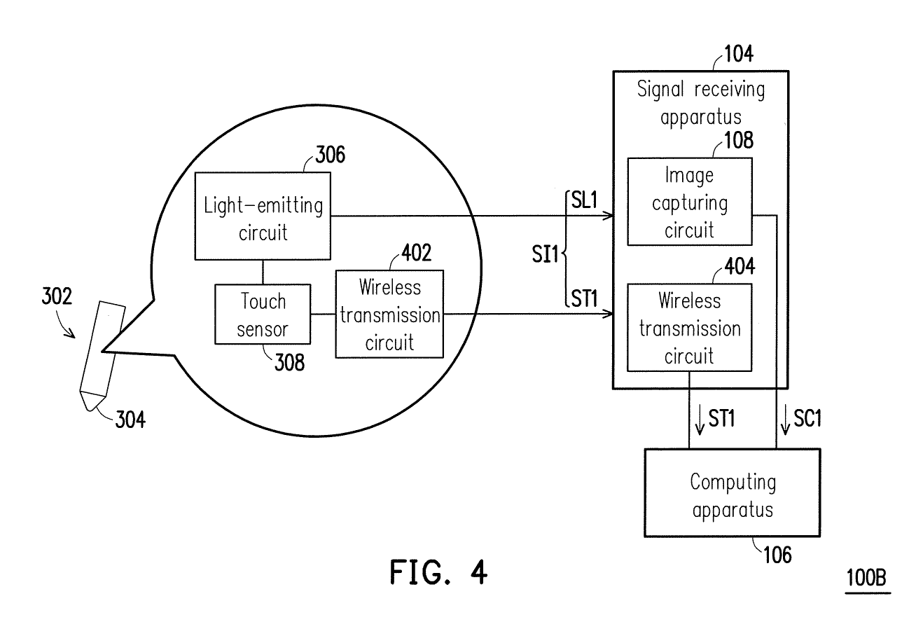

FIG. 4 is a schematic diagram of a touch system according to another embodiment of the invention. Referring to FIG. 4, in view of hardware configuration, a main difference between the touch system 100B of the embodiment and the touch system 100A of the embodiment of FIG. 3 is that the touch apparatus 302 of the embodiment further includes a wireless transmission circuit 402, and the signal receiving apparatus 104 further includes a wireless transmission circuit 404, wherein the wireless transmission circuit 402 is coupled to the touch sensor 308, and the wireless transmission circuit 404 is coupled to the computing apparatus 106. Moreover, in view of signal processing, a main difference between the image capturing circuit 108 of the embodiment and the image capturing circuit 108 of the embodiment of FIG. 3 is that the image capturing circuit 108 of the embodiment captures the first light signal SL1 without capturing a pressure sensing signal ST1, wherein the pressure sensing signal ST1, for example, does not belong to light signal. To be specific, in the embodiment, the touch sensor 308 of the touch apparatus 302 generates the pressure sensing signal ST1 according to a feedback pressure of the touch region, and transmits the pressure sensing signal ST1 to the wireless transmission circuit 404 of the signal receiving apparatus 104 through the wireless transmission circuit 402 of the touch apparatus 302 in a wireless manner, and the wireless transmission circuit 404 transmits the received pressure sensing signal ST1 to the computing apparatus 106. Moreover, in the embodiment, the image capturing circuit 108 may capture the first light signal SL1, and generate the corresponding coordinate signal SC1 to the computing apparatus 106. In the embodiment, the computing apparatus 106 may judge the touch position of the touch apparatus 302 according to the coordinate signal SC1 (corresponding to the first light signal SL1), and decide the expected size of the touch trajectory of the touch apparatus 302 according to the pressure sensing signal ST1 (corresponding to the feedback pressure). Application implemented by the computing apparatus 106 based on the expected size of the touch trajectory has been described in the aforementioned embodiment, and detail thereof is not repeated.

In the embodiment, the computing apparatus 106 and the wireless transmission circuits 404 of the signal receiving apparatus 104 may be integrated in a computer apparatus (for example, a PC/a micro-computer/a notebook computer/a tablet PC/a smart phone), though the invention is not limited thereto. In other embodiments, the wireless transmission circuit 404 may be externally connected to the computer apparatus (for example, a PC/a micro-computer/a notebook computer/a tablet PC/a smart phone) having the computing apparatus 106, wherein the wireless transmission circuit 402 and the wireless transmission circuit 404 may be circuits or chips with a WiFi, bluetooth or near field communication (NFC) function in wireless technical domain, which is not limited by the invention.

According to the above description, in the embodiment, the touch apparatus 302 is a touch pen, and the head portion 304 of the touch pen is, for example, a electroconductive rubber with a variable resistance, though the invention is not limited thereto. In the embodiment, the touch sensor 308, for example, has a voltage-dividing resistor and an ADC, and the light-emitting circuit 306, for example, has a light-emitting element, though the invention is not limited thereto. To be specific, referring to a following table 2, FIG. 3A and FIG. 4, in the embodiment, the variable resistance R of the head portion 304 (for example, electroconductive rubber) is, for example, connected in series with a voltage-dividing resistor Rd of the touch sensor 308 to form a voltage-dividing circuit, and since a force F exerted to the head portion 304 is related to the variable resistance R of the head portion 304, the force F sustained by the head portion 304 may be transformed into a corresponding voltage-dividing value (which is referred to as a voltage value V hereinafter) through the voltage-dividing circuit (shown in FIG. 3A), and the voltage value V may be converted into a corresponding digital value Q through the ADC. According to the table 2, it is known the force F exerted to the head portion 304, the variable resistance R of the head portion 304, the voltage value V obtained through the voltage-dividing circuit, the digital value Q converted by the ADC have corresponding relationships, and the corresponding relationships may be presented by a look-up table, though the invention is not limited thereto. In the table 2, since the digital value Q is related to the force F exerted to the head portion 304, a signal containing the digital value Q may be used to implement the pressure sensing signal ST1. Moreover, the circuit design of the touch apparatus 302 (for example, touch pen) of the aforementioned embodiment is only an example, and the invention is not limited thereto. Namely, any proper circuit design may be applied to the touch apparatus of the invention.

TABLE 2

| Force | | | |
|---|---|---|---|
| exerted | | | |
| to the | | Voltage | Digital |
| head | Variable | value | value |
| portion | resistance | V | Q |
| F | R | | |
| F(1) | R(1) | V(1) | Q(1) |
| F(i − 1) | R(i − 1) | V(i − 1) | Q(i − 1) |
| F(i) | R(i) | V(i) | Q(i) |
| F(i + 1) | R(i + 1) | V(i + 1) | Q(i + 1) |
| F(n) | R(n) | V(n) | Q(n) |

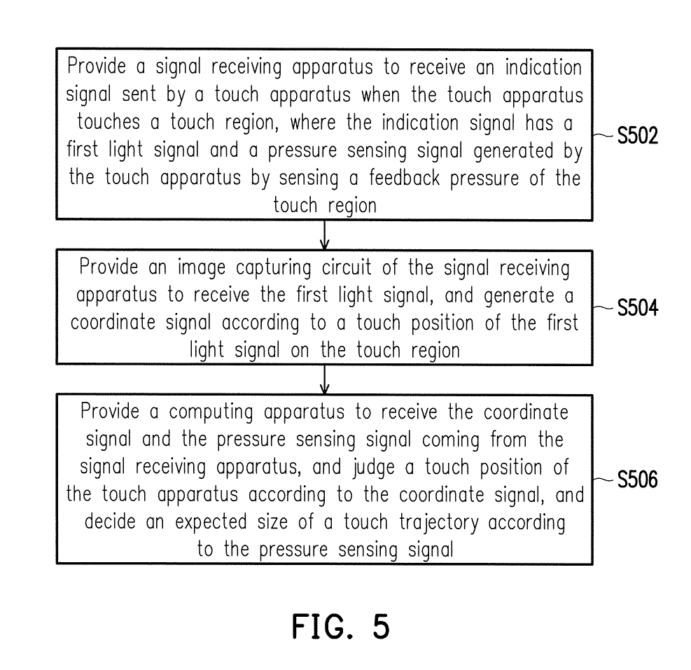

FIG. 5 is a flowchart illustrating a touch method of a touch system according to an embodiment of the invention. Referring to FIG. 5, according to the aforementioned embodiment, it is known that the touch method of the touch system includes following steps. First, a signal receiving apparatus is provided to receive an indication signal sent by a touch apparatus when the touch apparatus touches a touch region, wherein the indication signal has a first light signal and a pressure sensing signal generated by the touch apparatus by sensing a feedback pressure of the touch region (step S502). Then, an image capturing circuit of the signal receiving apparatus is provided to receive the first light signal, and a coordinate signal is generated according to a touch position of the first light signal on the touch region (step S504). Then, a computing apparatus is provided to receive the coordinate signal and the pressure sensing signal coming from the signal receiving apparatus, and a touch position of the touch apparatus is judged according to the coordinate signal, and an expected size of a touch trajectory is decided according to the pressure sensing signal (step S506).

For example, the touch apparatus is, for example, a touch pen, though the invention is not limited thereto. Moreover, in the embodiment, the touch region is, for example, a display surface, and the display surface is adapted to display the touch trajectory with the expected size at the touch position. In an embodiment, the image displayed on the display surface includes a projection image provided by a projector. In an embodiment, the display surface may be a wall surface, a projection screen, an electronic whiteboard or a touch display panel, though the invention is not limited thereto. In the embodiment, when the touch apparatus touches the touch region, the touch apparatus sends the first light signal, and senses the feedback pressure of the touch region to generate the pressure sensing signal. In an embodiment, the pressure sensing signal is, for example, a second light signal, and the touch apparatus may adjust a light intensity of the second light signal, and a contour size, color or wavelength of light spot according to the feedback pressure of the touch region, so as to adjust the optical characteristic of the indication signal. In an embodiment, the image capturing circuit of the signal receiving apparatus receives the first light signal and the second light signal (the pressure sensing signal) of the indication signal. In an embodiment, the image capturing circuit provides the optical characteristic information according to the optical characteristic of the indication signal, and the computing apparatus judges the touch position of the touch apparatus and decides the expected size of the touch trajectory according to the optical characteristic information, and decides the display image of the display surface (the touch region) to have the touch trajectory of a corresponding trace thickness degree (the expected size). In an embodiment, the image capturing circuit of the signal receiving apparatus receives the first light signal, and the signal receiving apparatus receives the pressure sensing signal, though the image capturing circuit of the signal receiving apparatus does not receive the pressure sensing signal, and the invention is not limited thereto.

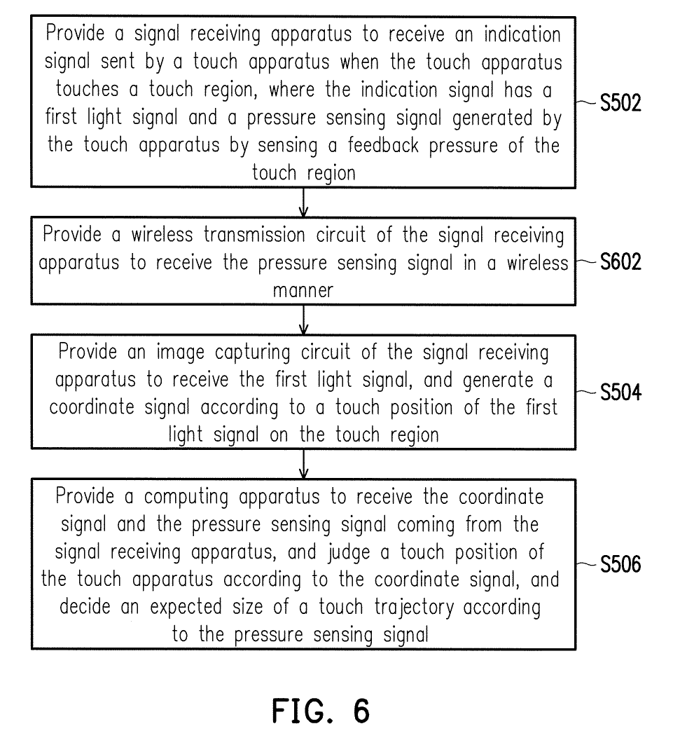

FIG. 6 is a flowchart illustrating a touch method of a touch system according to another embodiment of the invention. Referring to FIG. 6, compared to the touch method of the touch system of the embodiment of FIG. 5, the touch method of the touch system of the embodiment further includes a step S602, i.e. after the step S502, a wireless transmission circuit of the signal receiving apparatus is provided to receive the pressure sensing signal in a wireless manner. In an embodiment, a wireless transmission circuit of the touch apparatus is provided to transmit the pressure sensing signal to the signal receiving apparatus in the wireless manner. Namely, in the embodiment, the touch apparatus (for example, the touch pen, though the invention is not limited thereto) transmits the pressure sensing signal to the signal receiving apparatus in the wireless manner. Namely, in the embodiment, the first light signal and the pressure sensing signal are respectively a light signal and a wireless signal, and the image capturing circuit of the signal receiving apparatus receives the first light signal (light signal), and the wireless transmission circuit of the signal receiving apparatus receives the pressure sensing signal (the wireless signal) in the wireless manner, though the invention is not limited thereto.

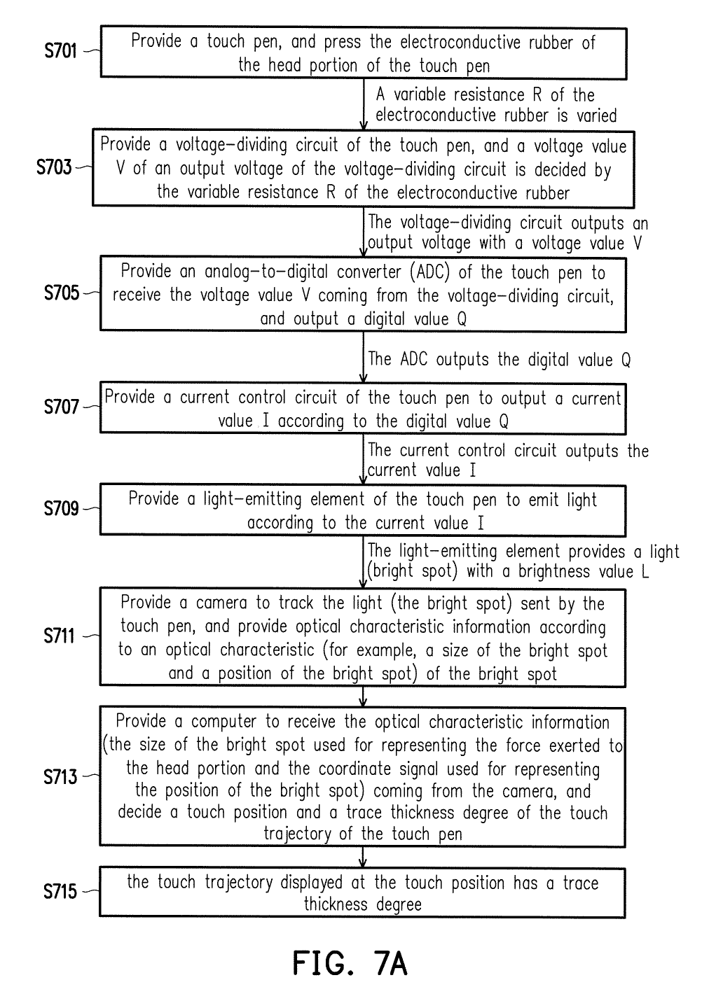

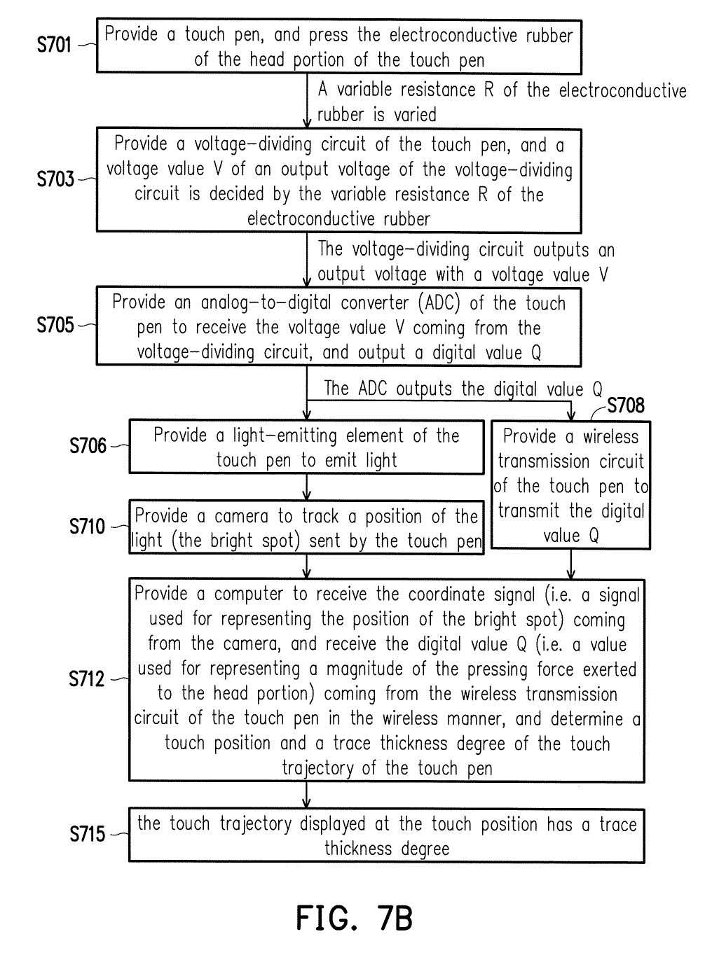

FIG. 7A is a flowchart illustrating a touch method of a touch system according to still another embodiment of the invention. Referring to FIG. 7A, according to the aforementioned embodiments, it is known that the touch method of the touch system includes following steps. First, in step S701, a touch pen is provided, and the electroconductive rubber of the head portion of the touch pen is pressed. In an embodiment, the touch apparatus is implemented by the touch pen, and by pressing the electroconductive rubber of the touch pen on the touch region, the variable resistance R of the electroconductive rubber is varied. In step S703, a voltage-dividing circuit of the touch pen is provided, wherein a voltage value V of an output voltage of the voltage-dividing circuit is decided by the variable resistance R of the electroconductive rubber (i.e. the resistance value of the variable resistance R of the electroconductive rubber may decide the voltage value V of the output voltage of the voltage-dividing circuit). In an embodiment, by changing the variable resistance R of the electroconductive rubber, the voltage value V of the output voltage of the voltage-dividing circuit is correspondingly changed. In step S705, an ADC of the touch pen is provided to receive the voltage value V coming from the voltage-dividing circuit, and output a digital value Q. In an embodiment, the ADC receives the voltage value V, and correspondingly outputs the digital value Q. In step S707, a current control circuit of the touch pen is provided to output a current value I according to the digital value Q. In an embodiment, the current control circuit receives the digital value Q, and correspondingly outputs the current value I. In step S709, a light-emitting element of the touch pen is provided to emit light according to the current value I. In an embodiment, the light-emitting element receives the current value I, and correspondingly emits light with a brightness value L (for example, a bright spot). In an embodiment, the pressure sensing signal sent by the touch apparatus is the brightness value L of the light (the bright spot), and the brightness value L of the light (the bright spot) is the second light signal, i.e. the indication signal sent by the touch apparatus includes the first light signal and the second light signal, wherein the first light signal corresponds to a position of the light (the bright spot) on the touch region, and the brightness value L (the second light signal) of the light (the bright spot) is generated by the touch apparatus by sensing the feedback pressure of the touch region. In step S711, a camera is provided to track the light (the bright spot) sent by the touch pen, and provide optical characteristic information according to an optical characteristic (for example, a size/light intensity of the bright spot and a position of the bright spot) of the bright spot. In an embodiment, the signal receiving apparatus includes a camera, wherein the camera receives the first light signal and the second light signal (the pressure sensing signal), and generates a coordinate signal according to a touch position of the first light signal on the touch region, and generates the optical characteristic information according to the second light signal (the pressure sensing signal). In step S713, a computer is provided to receive the optical characteristic information (i.e. the size/light intensity of the bright spot used for representing the force exerted to the head portion and the coordinate signal used for representing the position of the bright spot) coming from the camera, and a touch position and a trace thickness degree (the expected size) of the touch trajectory of the touch pen is decided. In an embodiment, the computer includes a computing apparatus, and the computer apparatus may determine (judge and decide, for example) the touch position of the touch apparatus and decide the expected size of the touch trajectory according to the optical characteristic information. In step S715, the touch trajectory displayed at the touch position has the trace thickness degree (the expected size). In an embodiment, a display surface is provided to display the touch trajectory with the expected size. In an embodiment, a projector is provided to project a projection image to the display surface, wherein the display surface has the touch region, and based on a pressing force for pressing the touch apparatus on the touch position of the touch region, the projector projects the touch trajectory with the corresponding trace thickness degree (the expected size) on the touch position, wherein the first light signal related to the touch position and the pressure sensing signal (the second light signal) related to a magnitude of the pressing force are, for example, all light signals, and the first light signal and the pressure sensing signal (the second light signal) provided by the touch apparatus are all received by, for example, the camera. However, the invention is not limited to the aforementioned embodiment.

FIG. 7B is a flowchart illustrating a touch method of a touch system according to still another embodiment of the invention. Referring to FIG. 7B, according to the aforementioned embodiments, it is known that the touch method of the touch system includes following steps. First, in step S701, a touch pen is provided, and the electroconductive rubber of the head portion of the touch pen is pressed. In an embodiment, the touch apparatus is implemented by the touch pen, and by pressing the electroconductive rubber of the touch pen on the touch region, the variable resistance R of the electroconductive rubber is varied. In step S703, a voltage-dividing circuit of the touch pen is provided, wherein a voltage value V of an output voltage of the voltage-dividing circuit is decide by the variable resistance R of the electroconductive rubber (i.e. the resistance value of the variable resistance R of the electroconductive rubber may decide the voltage value V of the output voltage of the voltage-dividing circuit). In an embodiment, by changing the variable resistance R of the electroconductive rubber, the voltage value V of the output voltage of the voltage-dividing circuit is correspondingly changed. In step S705, an ADC of the touch pen is provided to receive the voltage value V coming from the voltage-dividing circuit, and output a digital value Q. In an embodiment, the ADC receives the voltage value V, and correspondingly outputs the digital value Q. In step S706, a light-emitting element of the touch pen is provided to emit light. In an embodiment, the indication signal sent by the touch apparatus includes the first light signal and the pressure sensing signal, wherein the first light signal corresponds to a touch position of the touch apparatus on the touch region (i.e. a position that the touch apparatus emits light on the touch region), and the pressure sensing signal is generated by the touch apparatus by sensing the feedback pressure of the touch region, i.e. the pressure sensing signal corresponds to the digital value Q. In step S708, a wireless transmission circuit of the touch pen is provided to transmit the digital value Q in a wireless manner. In an embodiment, the pressure sensing signal transmitted by the touch apparatus in the wireless manner is the digital value Q. In step S710, a camera is provided to track a position of the light (the bright spot) sent by the touch pen. In an embodiment, the signal receiving apparatus includes a camera, wherein the camera receives the first light signal, and generates a coordinate signal according to the touch position of the first light signal on the touch region. In step S712, a computer is provided to receive the coordinate signal (i.e. a signal used for representing the position of the bright spot) coming from the camera, and receive the digital value Q (i.e. a value used for representing a magnitude of the pressing force exerted to the head portion) coming from the wireless transmission circuit of the touch pen in the wireless manner, and decide a touch position and a trace thickness degree (the expected size) of the touch trajectory of the touch pen. In an embodiment, the computer includes a wireless transmission circuit and a computing apparatus, wherein the wireless transmission circuit may receive the pressure sensing signal (the digital value Q) in the wireless manner, and the computer apparatus may determine (judge and decide, for example) the touch position of the touch apparatus according to the coordinate signal (corresponding to the first light signal), and decide the expected size of the touch trajectory according to the pressure sensing signal (the digital value Q). In step S715, the touch trajectory displayed at the touch position has the trace thickness degree (the expected size). In an embodiment, a display surface is provided to display the touch trajectory with the expected size. In an embodiment, a projector is provided to project a projection image to the display surface, wherein the display surface has the touch region, and based on a pressing force for pressing the touch apparatus on the touch position of the touch region, the projector projects the touch trajectory with the corresponding trace thickness degree (the expected size) on the touch position, wherein the first light signal related to the touch position is a light signal, and the pressure sensing signal related to a magnitude of the pressing force is, for example, a wireless signal, and the first light signal and the pressure sensing signal (the wireless signal) provided by the touch apparatus are, for example, respectively received by the computer and the camera. However, the invention is not limited to the aforementioned embodiment.

Moreover, the lights, light spots, bright spots or light signals, etc., of the invention are not limited to be visible lights visible to human eyes, and invisible lights or light wave characteristics such as color/wavelength/wave band, etc., of lights are also within the scope of the invention.

In summary, the signal receiving apparatus of the touch system of the embodiment of the invention may receive the first light signal and the pressure sensing signal sent by the touch apparatus. Moreover, the computing apparatus of the embodiment of the invention judges the touch position of the touch apparatus according to the first light signal and decides the expected size of the touch trajectory according to the pressure sensing signal, so as to generate a corresponding touch effect in response to a magnitude of a pressing force to improve applicability of the touch system. For example, the computing apparatus may change a trace thickness degree of the touch trajectory displayed by the display surface according to the expected size of the touch trajectory, or the computing apparatus may perform volume adjustment or image brightness adjustment according to the expected size of the touch trajectory, so as to further improve applicability of the touch system.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch system, comprising:
a touch apparatus, configured to send an indication signal when a touch region is touched, wherein the indication signal has a first light signal and a pressure sensing signal generated by the touch apparatus by sensing a feedback pressure of the touch region;
a signal receiving apparatus, configured to receive the first light signal and the pressure sensing signal from the touch apparatus, wherein the signal receiving apparatus comprises an image capturing circuit, and the image capturing circuit is configured to receive the first light signal, and the image capturing circuit generates a coordinate signal according to a touch position of the first light signal on the touch region; and
a computing apparatus, coupled to the signal receiving apparatus, and configured to receive the coordinate signal and the pressure sensing signal from the signal receiving apparatus, and configured to judge the touch position of the touch apparatus according to the coordinate signal, and configured to decide an expected size of a touch trajectory according to the pressure sensing signal.

2. The touch system as claimed in claim 1, wherein the image capturing circuit of the signal receiving apparatus is coupled to the computing apparatus, and is configured to capture the first light signal, and the signal receiving apparatus further comprises:
a wireless transmission circuit, coupled to the computing apparatus, and configured to receive the pressure sensing signal in a wireless manner, and configured to transmit the pressure sensing signal to the computing apparatus.

3. The touch system as claimed in claim 1, wherein the touch apparatus is a touch pen, and the touch pen comprises:
a head portion, configured to touch the touch region;
a light-emitting circuit, coupled to the head portion, and configured to send the first light signal when the head portion touches the touch region; and
a touch sensor, coupled to the light-emitting circuit and the head portion, and the touch sensor is configured to sense the feedback pressure of the touch region when the head portion touches the touch region.

4. The touch system as claimed in claim 3, wherein the touch sensor is configured to control the light-emitting circuit to generate the pressure sensing signal according to the feedback pressure of the touch region, the pressure sensing signal is a second light signal, and the light-emitting circuit is controlled by the touch sensor to adjust an optical characteristic of the indication signal, the image capturing circuit is configured to provide optical characteristic information according to the optical characteristic of the indication signal, and the computing apparatus is further configured to judge the touch position of the touch apparatus and decide the expected size of the touch trajectory according to the optical characteristic information.

5. The touch system as claimed in claim 4, wherein the optical characteristic of the indication signal comprises a light intensity of the indication signal.

6. The touch system as claimed in claim 3, wherein the touch pen further comprises:
a wireless transmission circuit, coupled to the touch sensor, wherein the touch sensor is configured to generate the pressure sensing signal according to the feedback pressure of the touch region, and the wireless transmission circuit transmits the pressure sensing signal to the signal receiving apparatus in a wireless manner.

7. The touch system as claimed in claim 1, wherein the touch region is a display surface, and the display surface is configured to display the touch trajectory with the expected size at the touch position.

8. The touch system as claimed in claim 7, wherein an image displayed on the display surface comprises a projection image provide by a projector.

9. A touch method of a touch system, comprising:
providing a signal receiving apparatus, and receiving an indication signal sent by a touch apparatus when the touch apparatus touches a touch region, wherein the indication signal has a first light signal and a pressure sensing signal generated by the touch apparatus by sensing a feedback pressure of the touch region;
providing an image capturing circuit of the signal receiving apparatus, receiving the first light signal, and generating a coordinate signal according to a touch position of the first light signal on the touch region; and
providing a computing apparatus, receiving the coordinate signal and the pressure sensing signal from the signal receiving apparatus, judging the touch position of the touch apparatus according to the coordinate signal, and deciding an expected size of a touch trajectory according to the pressure sensing signal.

10. The touch method of the touch system as claimed in claim 9, wherein the image capturing circuit captures the first light signal, and the touch method of the touch system further comprises:
providing a wireless transmission circuit of the signal receiving apparatus, receiving the pressure sensing signal in a wireless manner, and transmitting the pressure sensing signal to the computing apparatus.

11. The touch method of the touch system as claimed in claim 9, wherein the pressure sensing signal is a second light signal, and the touch apparatus adjusts an optical characteristic of the indication signal according to the feedback pressure of the touch region, the image capturing circuit provides optical characteristic information according to the optical characteristic of the indication signal, and the computing apparatus judges the touch position of the touch apparatus and decides the expected size of the touch trajectory according to the optical characteristic information.

12. The touch method of the touch system as claimed in claim 11, wherein the optical characteristic of the indication signal comprises a light intensity of the indication signal.

13. The touch method of the touch system as claimed in claim 9, further comprising:
transmitting the pressure sensing signal to the signal receiving apparatus though the touch apparatus in a wireless manner.

14. The touch method of the touch system as claimed in claim 9, further comprising:
providing a display surface, displaying the touch trajectory with the expected size, wherein the touch trajectory is located at the touch position.
